(19) United States
(12) Patent Application Publication
(10) Pub. No.: US 2015/0333909 A1
(43) Pub. Date: Nov. 19, 2015

(54) INFORMATION PROCESSING SYSTEM AND INFORMATION PROCESSING METHOD

(71) Applicants: Tetsuhiko OMORI, Chiba (JP); Seijiro HORI, Tokyo (JP)

(72) Inventors: Tetsuhiko OMORI, Chiba (JP); Seijiro HORI, Tokyo (JP)

(73) Assignee: RICOH COMPANY, LTD., Tokyo (JP)

(21) Appl. No.: 14/700,544

(22) Filed: Apr. 30, 2015

(30) Foreign Application Priority Data
May 15, 2014 (JP) 2014-101334
May 26, 2014 (JP) 2014-107754

(51) Int. Cl. H04L 9/32; H04L 29/06

(52) U.S. Cl. CPC H04L 9/3213; H04L 9/3242; H04L 63/08

(57) ABSTRACT

An information processing system is provided in which a first information processing apparatus generates a hash value of predetermined information when authentication is successfully performed with respect to information transmitted from a client apparatus, generates encrypted data by encrypting the hash value using a first encryption key, and transmits the encrypted data and the predetermined information to a client apparatus. A second information processing apparatus receives a request including the encrypted data and the predetermined information that is transmitted from the client apparatus, decrypts the encrypted data using a second encryption key that is the same as the first encryption key or forms a pair with the first encryption key, generates a hash value of the predetermined information included in the received request, compares the decryption result with the generated hash value, and executes a process in response to the request according to the comparison result.

### BACKGROUND OF THE INVENTION

1. Field of the Invention

The present invention relates to an information processing system and an information processing method.

2. Description of the Related Art

Single sign-on (SSO) is a known technique for enabling use of multiple servers through one authentication process. The basic mechanism of single sign-on is described below.

In response to an authentication request from a client, server A executes an authentication process. If the authentication process is successfully executed, the server A generates a token of which validity may be verified by the server A and returns the generated token to the client.

The client sends the token to server B and requests for a service provided by the server B. The server B requests the server A to verify the token. If the validity of the token is verified by the server A, the server B provides the requested service to the client.

According to the above-described mechanism, if communication between the server A and the server B is disabled, there is an increased possibility that single sign-on cannot be properly implemented.

### SUMMARY OF THE INVENTION

An aspect of the present invention is directed to reducing dependency on communication in implementing single sign-on.

According to one embodiment of the present invention, an information processing system is provided that includes a first information processing apparatus and a second information processing apparatus. The first information processing apparatus includes an authentication unit configured to perform an authentication process with respect to information transmitted from a client apparatus, a first generating unit configured to generate a hash value of predetermined information in a case where the authentication process by the authentication unit is successful, an encryption unit configured to generate encrypted data by encrypting the hash value generated by the first generating unit using a first encryption key, and a response unit configured to transmit the encrypted data and the predetermined information to the client apparatus. The second information processing apparatus includes a request receiving unit configured to receive a request including the encrypted data generated by the encryption unit and the predetermined information transmitted from the client apparatus, a decryption unit configured to decrypt the encrypted data included in the request received by the request receiving unit using a second encryption key that may be the same as the first encryption key or form a pair with the first encryption key, a second generating unit configured to generate a hash value of the predetermined information included in the request received by the request receiving unit, and a comparison unit configured to compare the decryption result obtained by the decryption unit with the hash value generated by the second generating unit. The second information processing apparatus executes a process in response to the request according to the comparison result of the comparison unit.

### BRIEF DESCRIPTION OF THE DRAWINGS

FIG. 1 illustrates an exemplary configuration of an information processing system according to a first embodiment of the present invention;

FIG. 2 illustrates an exemplary hardware configuration of a server apparatus;

FIG. 3 illustrates an exemplary functional configuration of the information processing system according to the first embodiment;

FIG. 4 illustrates an exemplary relationship between data constituting a subject;

FIG. 5 is a sequence chart illustrating exemplary process steps of a single sign-on process;

FIG. 6 is a flowchart illustrating an exemplary authentication process;

FIG. 7 is a table illustrating an exemplary configuration of a user information storage unit;

FIG. 8 is a flowchart illustrating exemplary process steps of a request response process that is executed in response to a request accompanied by a subject;

FIG. 9 illustrates an exemplary configuration of an information processing system according to a second embodiment of the present invention;

FIG. 10 illustrates an exemplary functional configuration of the information processing system according to the second embodiment; and

FIG. 11 is a sequence chart illustrating exemplary process steps of a delivery process for delivering an encryption key to a server apparatus.

### DESCRIPTION OF THE PREFERRED EMBODIMENTS

In the following, embodiments of the present invention are described with reference to the accompanying drawings.

### First Embodiment

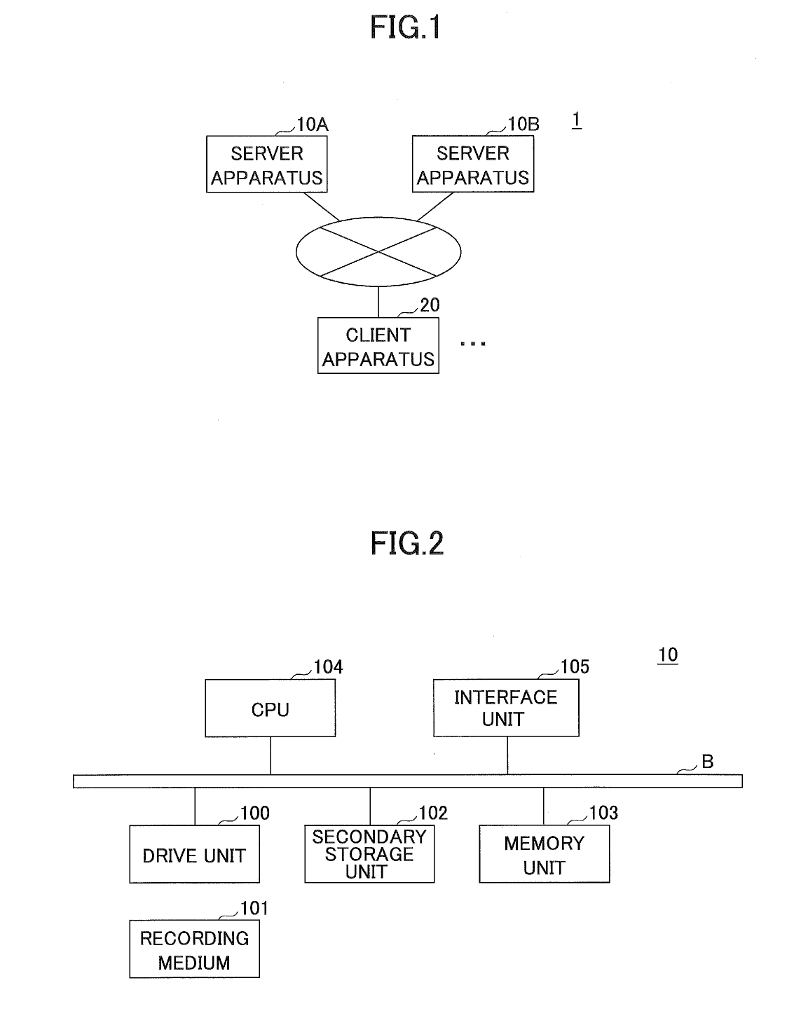

FIG. 1 illustrates an exemplary configuration of an information processing system 1 according to a first embodiment of the present invention. In FIG. 1, the information processing system 1 includes a server apparatus 10A, a server apparatus 10B, and one or more client apparatuses 20 that are interconnected by a network such as a LAN (Local Area Network) or the Internet. Note that in the following descriptions, the server apparatus 10A and the server apparatus 10B may simply be referred to as “server apparatus 10” when their distinction is not particularly relevant.

The server apparatus 10 may be a computer or a group of one or more computers that is configured to provide a predetermined service to an authenticated user. The server apparatus 10 may also be implemented by a device such as an image forming apparatus, for example.

The client apparatus 20 is a terminal that acts as user interface when a user uses a service provided by the server apparatus 10. For example, the client apparatus 20 may be implemented by a PC (personal computer), a smartphone, a tablet terminal, a mobile phone, and the like. The client apparatus 20 may also be implemented by a device such as an image forming apparatus, for example.

In the present embodiment, an exemplary case is described where a user that is authenticated by the server apparatus 10A is allowed to use not only a service provided by the server apparatus 10A but also a service provided by the server apparatus 10B. That is, an exemplary case of implementing single sign-on with respect to the use of the server apparatus 10A and server apparatus 10B is described below. Note that network communication does not necessarily have to be established between the server apparatus 10A and the server apparatus 10B. Also, in some embodiments, three or more server apparatuses 10 may be included in the information processing system 1.

FIG. 2 illustrates an exemplary hardware configuration of the server apparatus 10. In FIG. 2, the server apparatus 10 includes a drive unit 100, a secondary storage unit 102, a memory unit 103, a CPU (central processing unit) 104, and an interface unit 105 that are interconnected by a bus B.

A program for executing a process at the server apparatus 10 may be provided by a recording medium 101 such as a CD-ROM. When the recording medium 101 storing the program is loaded into the drive unit 100, the program may be installed on the secondary storage unit 102 from the recording medium 101 via the drive unit 100. Note, however, that the program does not necessarily have to be installed from the recording medium 101, and may alternatively be downloaded from some other computer via a network, for example. The secondary storage unit 102 stores files and data in addition to installed programs.

The memory unit 103 reads a program from the secondary storage unit 102 and stores the read program in response to an instruction to activate the program. The CPU 104 implements a function of the server apparatus 10 by executing a relevant program stored in the memory unit 103. The interface unit 105 is used as an interface for establishing connection with a network.

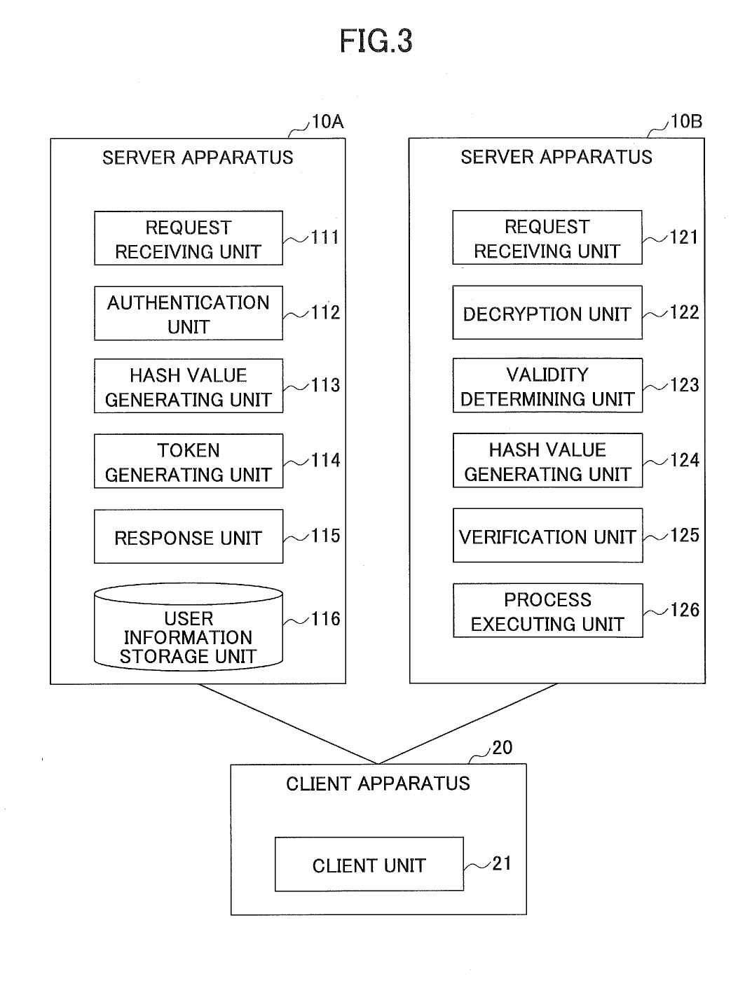

FIG. 3 illustrates an exemplary functional configuration of the information processing system 1 according to the present embodiment. In FIG. 3, the client apparatus 20 includes a client unit 21. The client unit 21 performs operations such as providing a user interface for using the server apparatus 10, transmitting a request to the server apparatus 10, receiving information returned from the server apparatus 10 in response to the request, and displaying the received information, for example. The client unit 21 may be implemented by a dedicated application program or a web browser program causing a CPU of the client apparatus 20 to execute a corresponding process, for example.

The server apparatus 10A includes a request receiving unit 111, an authentication unit 112, a hash value generating unit 113, a token generating unit 114, and a response unit 115. These units may be implemented by a relevant process executed by the CPU 104 of the server apparatus 10A based on a program installed in the server apparatus 10A, for example. Also, the server apparatus 10A includes a user information storage unit 116. The user information storage unit 116 may be implemented by the secondary storage unit 102 of the server apparatus 10A or a storage that is connected to the server apparatus 10A via a network, for example.

The request receiving unit 111 receives a request transmitted from the client unit 21. The authentication unit 112 executes an authentication process with respect to authentication information included in the request from the client unit 21 in a case where the request from the client unit 21 corresponds to a login request. The authentication process may be performed by comparing the authentication information included in the login request with authentication information stored in the user information storage unit 116, for example. The authentication information may be a user name and a password, for example. Alternatively, in a case where an IC card is used, the authentication information may be card information, for example. Also, if biometric authentication is implemented, the authentication information may be biometric information, for example.

The user information storage unit 116 stores information such as authentication information and attribute information associated with each user that is permitted to use the information processing system 1. In the following descriptions, such information including the authentication information and the attribute information is referred to as user information.

The hash value generating unit 113 generates a hash value of a part or all of user information of a user that has been successfully authenticated by the authentication unit 112. In the following descriptions, a part or all of the user information that is used to generate the hash value is referred to as “hash source information”.

The token generating unit 114 encrypts the hash value generated by the hash value generating unit 113 and information indicating a validity period using an encryption key. The data generated by such an encryption is hereinafter referred to as “token”. Note that the information indicating a validity period may be date and time information indicating an expiration date of the token, for example. The encryption key may be stored in the secondary storage unit 102 of the server apparatus 10A, for example. Also, in some embodiments, the encryption key may be stored using a security chip or the like, for example.

The response unit 115 returns a response to the request received by the request receiving unit 111 to the client unit 21 corresponding to the sender of the request. For example, in a case where the request is a login request and an authentication process is successfully executed by the authentication unit 112, the response unit 115 returns a token generated by the token generating unit 114 and the hash source information associated with the token to the client unit 21 corresponding to the sender of the login request. The combination of the token and the hash source information is hereinafter referred to as “subject”.

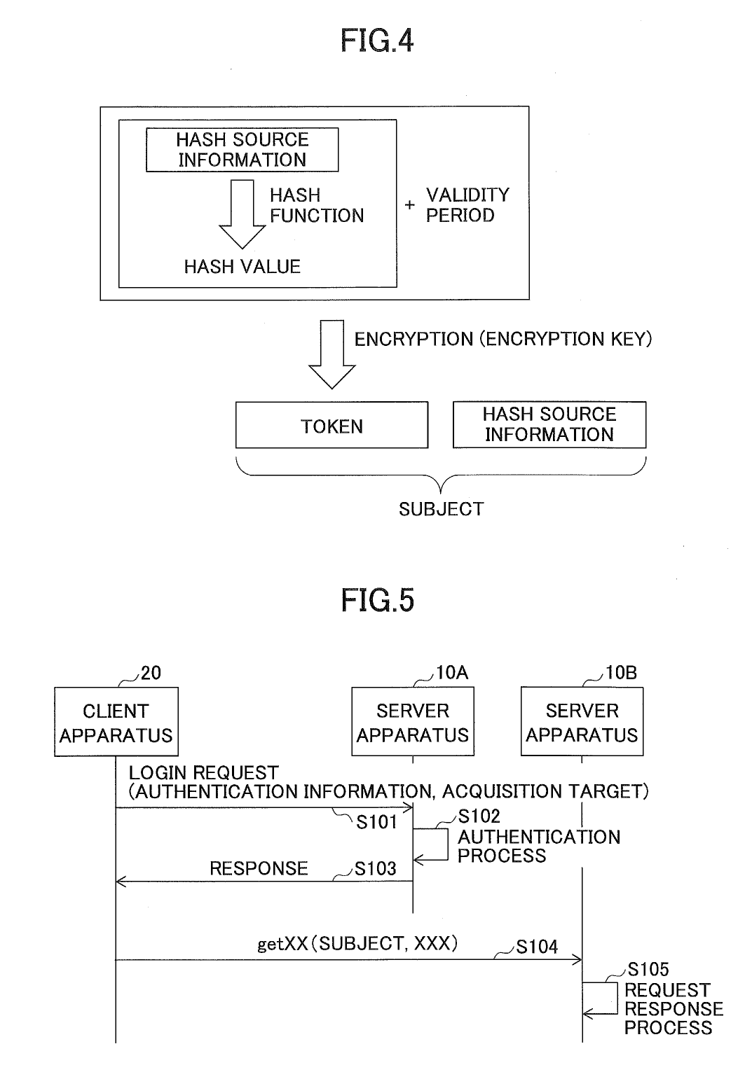

FIG. 4 illustrates an exemplary relationship between data constituting the subject. As illustrated in FIG. 4, the subject includes a token and hash source information. The token is generated by encrypting a hash value of the hash source information and date and time information indicating the validity period of the token.

Referring back to FIG. 3, the server apparatus 10B includes a request receiving unit 121, a decryption unit 122, a validity determining unit 123, a hash value generating unit 124, a verification unit 125, and a process executing unit 126. These units may be implemented by a relevant process executed by the CPU 104 of the server apparatus 10B based on a program installed in the server apparatus 10B, for example.

The request receiving unit 121 receives a request transmitted from the client unit 21 corresponding to the recipient of the subject generated by the server apparatus 10A. Such a request includes the subject generated by the server apparatus 10A.

The decryption unit 122 decrypts the token in the subject included in the request received by the request receiving unit 121 using an encryption key. The encryption key may be stored in the secondary storage unit 102 of the server apparatus 10B, for example. Also, in some embodiments, the encryption key may be stored using a security chip, for example. Note that in some embodiments, the encryption key used by the decryption unit 122 may be the same as the encryption key used by the token generating unit 114, for example. In other embodiments, the encryption key used by the decryption unit 122 may be asymmetrical to the encryption key used by the token generating unit 114, for example. That is, the encryption key used by the token generating unit 114 may be a private key, and the encryption key used by the decryption unit 122 may be a public key that forms a pair with the private key used by the token generating unit 114.

The validity determining unit 123 determines whether the token is within its validity period based on the information indicating the expiration date and time obtained by decrypting the token.

The hash value generating unit 124 generates a hash value of the hash source information contained in the subject that is included in the request received by the request receiving unit 121. To generate the hash value, the hash value generating unit 124 uses a hash function that is identical to the hash function used by the hash value generating unit 113.

The verification unit 125 verifies the validity of the subject by comparing a hash value obtained as a token decryption result by the decryption unit 122 and the hash value generated by the hash value generating unit 124. That is, if the compared hash values match, it may be verified that the token has been generated by the server apparatus 10A and that the hash source information has not been tampered with, for example. Note, however, that such a verification is made under the premise that the encryption key in the server apparatus 10A has not been leaked.

Based on the comparison result of the verification unit 125, the process executing unit 126 executes a process in response to the request received by the request receiving unit 121.

Note that in some embodiments, the server apparatus 10A may further include the functional features of the server apparatus 10B. Also, the server apparatus 10B may further include the functional features of the server apparatus 10A.

In the following, process steps that are executed in the information processing system 1 are described. FIG. 5 is a sequence chart illustrating exemplary process steps of a single sign-on process executed in the information processing system 1.

In step S101, the client unit 21 of the client apparatus 20 transmits to the server apparatus 10A a login request including authentication information input via a login screen, for example. The login request also includes the item names of one or more acquisition target items of the information items constituting the user information of the user associated with the authentication information. For example, the acquisition target items may include information items such as “user name”, “name”, and “email address”. In the present embodiment, for convenience, an exemplary case is described in which a user name and a password are used as the authentication information.

The login request is received by the request receiving unit 111 of the server apparatus 10A. Upon receiving the login request, the server apparatus 10A executes an authentication process (step S102). Note that the authentication process is described in detail below. Then, the response unit 115 of the server apparatus 10A returns a response to the login request to the client unit 21 (step S103). If the authentication process has been successful, the response includes a subject. If the authentication process has failed, the response may include information indicating that the authentication process has failed, for example.

If the authentication process has been successful, the client unit 21 transmits to the server apparatus 10B a request for a service (step S104). In FIG. 5, an example is illustrated in which an API (Application Program Interface) called “getXX” is invoked as the request. The request may designate the subject that has been returned in step S103 and arguments that are unique to “getXX”.

The request is received by the request receiving unit 121 of the server apparatus 10B. Upon receiving the request, the server apparatus 10B executes a request response process in response to the request from the client apparatus 20 (step S105).

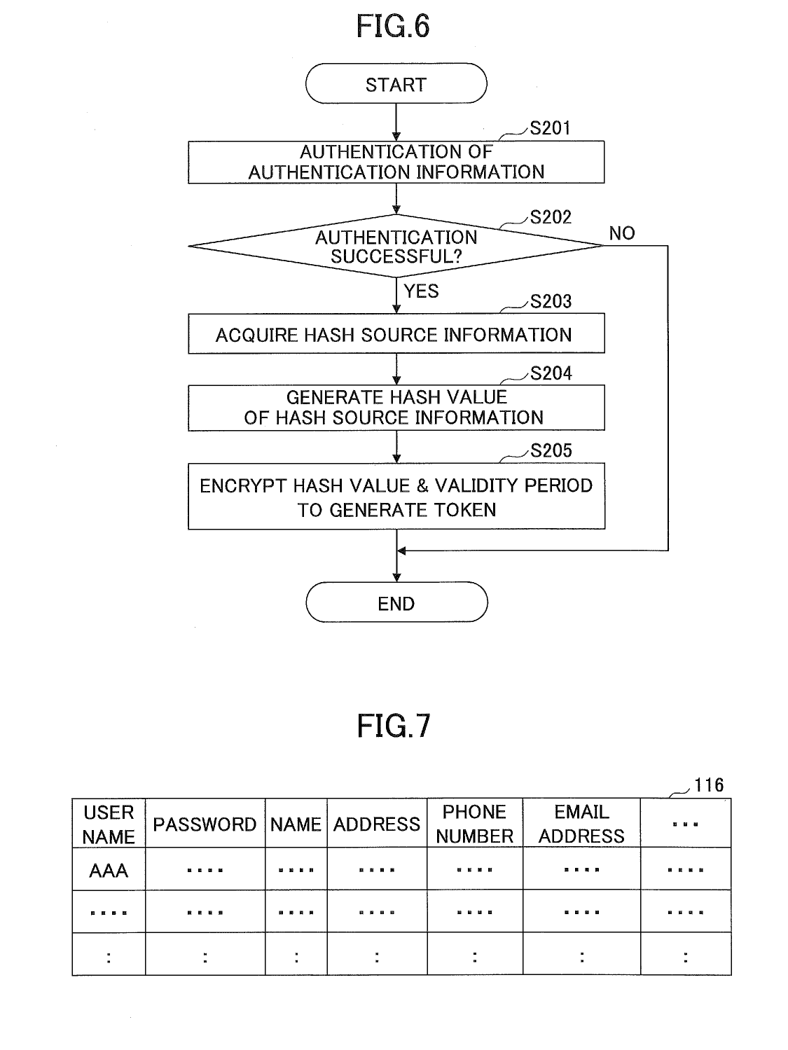

In the following, the authentication process of step S102 is described in greater detail. FIG. 6 is a flowchart illustrating exemplary process steps of the authentication process.

In step S201, the authentication unit 112 performs an authentication process with respect to the authentication information included in the login request by referring to the authentication information stored in the user information storage unit 116.

FIG. 7 is a table illustrating an exemplary configuration of the user information storage unit 116. In FIG. 7, the user information storage unit 116 stores, for each user, a user name, a password, a name, an address, a phone number, and an email address.

The user name is information for enabling a computer or a device constituting the information processing system 1 to identify each user. The password is a user password associated with the user name. Note that in a case where information other than a password (e.g., card information, biometric information, etc.) is used in the authentication process, the password does not necessarily have to be stored in the user information storage unit 116. The name, address, phone number, and email address are respectively information indicating the name, the address, the phone number, and the email address of the user associated with the user name.

Referring back to FIG. 6, if a record containing the user name and the password included in the login request is found in the user information storage unit 116 in step S201, the authentication unit 112 determines that the authentication process is successful. If such a record is not stored in the information storage unit 116, the authentication unit 112 determines that that the authentication process has failed.

In the case where the authentication process has failed (NO in step S202), step S203 and subsequent process steps are not executed. In this case, the process may proceed to step S103 of FIG. 5, where the response unit 115 returns to the client unit 21 a response including information indicating that the authentication process has failed, for example.

On the other hand, if the authentication process has been successful (YES in step S202), the authentication unit 112 acquires from the user information storage unit 116 the information items specified as the acquisition target items in the login request (step S203). For example, the authentication unit 112 may acquire the values of the information items “user name”, “name”, and “email address” associated with the user that has been successfully authenticated.

Then, the hash value generating unit 113 uses the acquired information as hash source information and generates a hash value of the hash source information (step S204). Note that the hash source information may be information including the item names of the acquired information and their corresponding values in a predetermined format such as “user name: XXX, name: YYY, email address: ZZZ”, for example.

Then, the token generating unit 114 generates a token by encrypting the hash value generated by the hash value generating unit 113 and the date and time information indicating the validity period of the token using an encryption key stored in the server apparatus 10A (step S205). Note that the information indicating the validity period may be information indicating a date and time after a certain time period elapses from the current date and time, for example.

In the case where step S205 is executed, the process proceeds to step S103 of FIG. 5 where the response unit 115 returns to the client unit 21 a response including a subject containing the generated token and the hash source information.

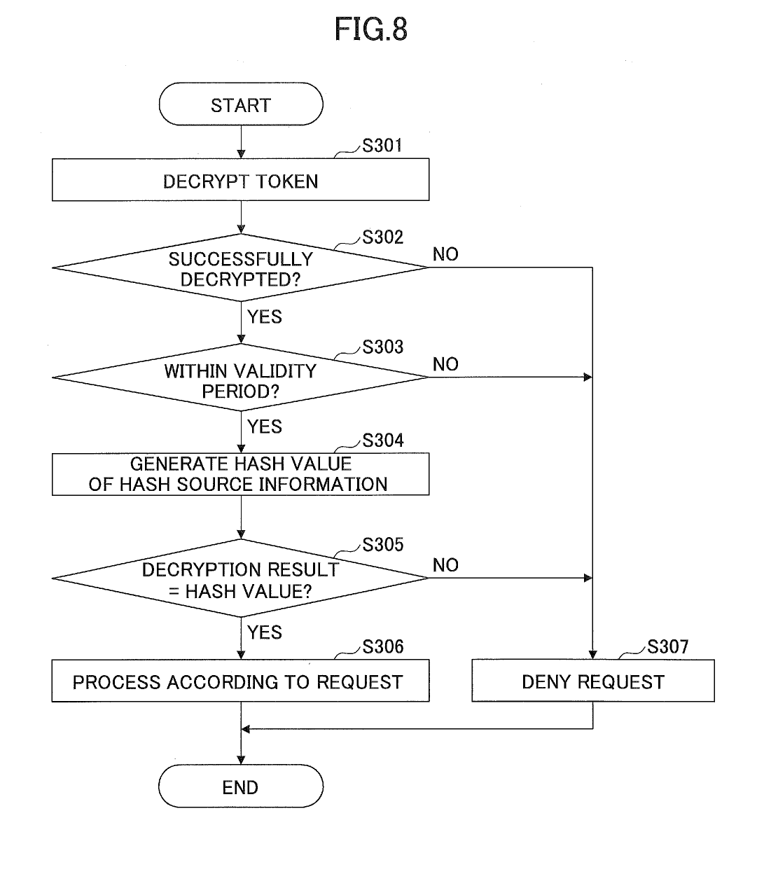

In the following, the request response process of step S105 of FIG. 5 is described in greater detail. FIG. 8 is a flowchart illustrating exemplary process steps of a request response process that is executed in response to a request accompanied by a subject.

In step S301, the decryption unit 122 decrypts the token included in the received subject using an encryption key stored in the server apparatus 10B. If the decryption fails (NO in step S302), the process executing unit 126 denies execution of the requested process (step S307). This is because the token included in the received subject is most likely not a token that has been generated by the server apparatus 10A in this case. In other words, the fact that decryption of the token included in the received subject is successful indicates a high likelihood that the token has been generated by the server apparatus 10A.

In the case where decryption has been successful (YES in step S302), the validity determining unit 123 determines whether the token is within its validity period based on the information indicating the validity period obtained by decrypting the token (step S303). For example, if the information indicating the validity period reveals that the current date and time is before the expiration date and time of the token, the validity determining unit 123 may determine that the token is within its validity period.

If the token is not within its validity period (NO in step S303), the process executing unit 126 denies execution of the requested process (step S307).

If the token is within its validity period (YES in step S303), the hash value generating unit 124 generates a hash value of the hash source information included in the received subject (step S304). Then, the verification unit 125 determines whether the hash value obtained by decrypting the token matches the hash value generated by the hash value generating unit 124 (step S305). If the compared hash values do not match (NO in step S305), the process executing unit 126 denies execution of the requested process (step S307). This is because the hash source information has most likely been tampered with in this case and the request is therefore most likely illegitimate. In the present embodiment, the hash source information includes user identification information such as the user name. Thus, the hash source information may be tampered with for the purpose of impersonation, for example.

On the other hand, if the compared hash values match (YES in step S305), the process executing unit 126 executes the requested process (step S306). Note that in some embodiments, the process executing unit 126 may change the specific manner in which the requested process is executed depending on the user name included in the hash source information. For example, the execution of a process may be restricted based on authority information that is managed in association with the user name.

Note that the client unit 21 may transmit a request for a service to the server apparatus 10A between step S103 and step S104 of FIG. 5. A subject is specified in such a request for a service transmitted to the server apparatus 10A. In response to receiving such a request, the server apparatus 10A may perform a process substantially identical to the process illustrated in FIG. 8. The client unit 21 may also transmit a request for a service specifying a subject to a server apparatus 10 other than the server apparatus 10A and the server apparatus 10B. In response, the server apparatus 10 that receives such a request may perform a process substantially identical to the process illustrated in FIG. 8.

Note that in some embodiments, the token does not have to have a validity period. In this case, the token may be generated by encrypting the hash value of the hash source information.

Also, the hash source information does not necessarily have to be user information. For example, the hash source information may be bibliographic information of a document or even information that has no special meaning.

As described above, according an aspect of the present embodiment, single sign-on may be achieved even when communication is not established between the server apparatus 10A and the server apparatus 10B. In other words, even if communication between the server apparatus 10A and the server apparatus 10B is disabled, single sign-on with respect to the server apparatus 10A and the server apparatus 10B may still be achieved. In this way, dependency on communication in implementing single sign-on may be reduced.

### Second Embodiment

In the following a second embodiment of the present invention is described with reference to the accompanying drawings. Note that in the descriptions below, features of the second embodiment that substantially correspond to those of the first embodiment are given the same reference numerals and overlapping descriptions thereof may be omitted.

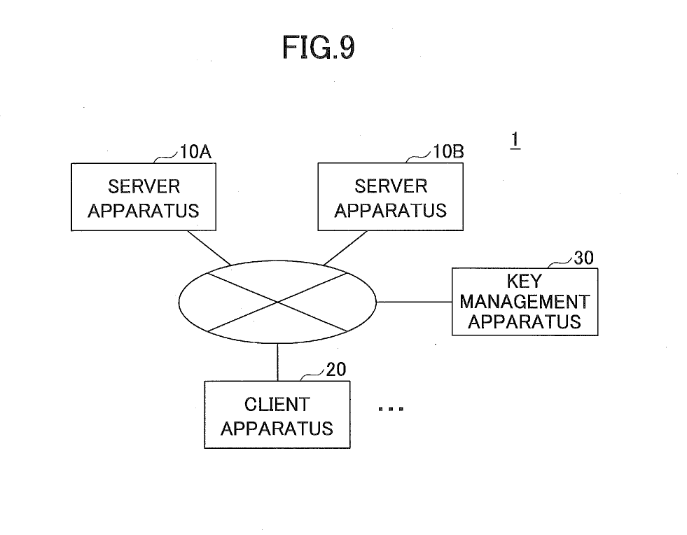

FIG. 9 illustrates an exemplary configuration of the information processing system 1 according to the second embodiment. In FIG. 9, the information processing system 1 includes a key management apparatus 30 in addition to the server apparatus 10A, the server apparatus 10B, and the one or more client apparatuses 20. The server apparatuses 10 and the one or more client apparatuses 20 are interconnected via a network such as a LAN or the Internet. Also, the server apparatuses 10 and the key management apparatus 30 are interconnected via a network such as a LAN or the Internet.

The key management apparatus 30 is a computer that is configured to periodically deliver to each of the server apparatuses 10, at synchronized timings, an encryption key to be used by each of the server apparatuses 10.

Note that the key management apparatus 30 may have a hardware configuration as illustrated in FIG. 2, for example.

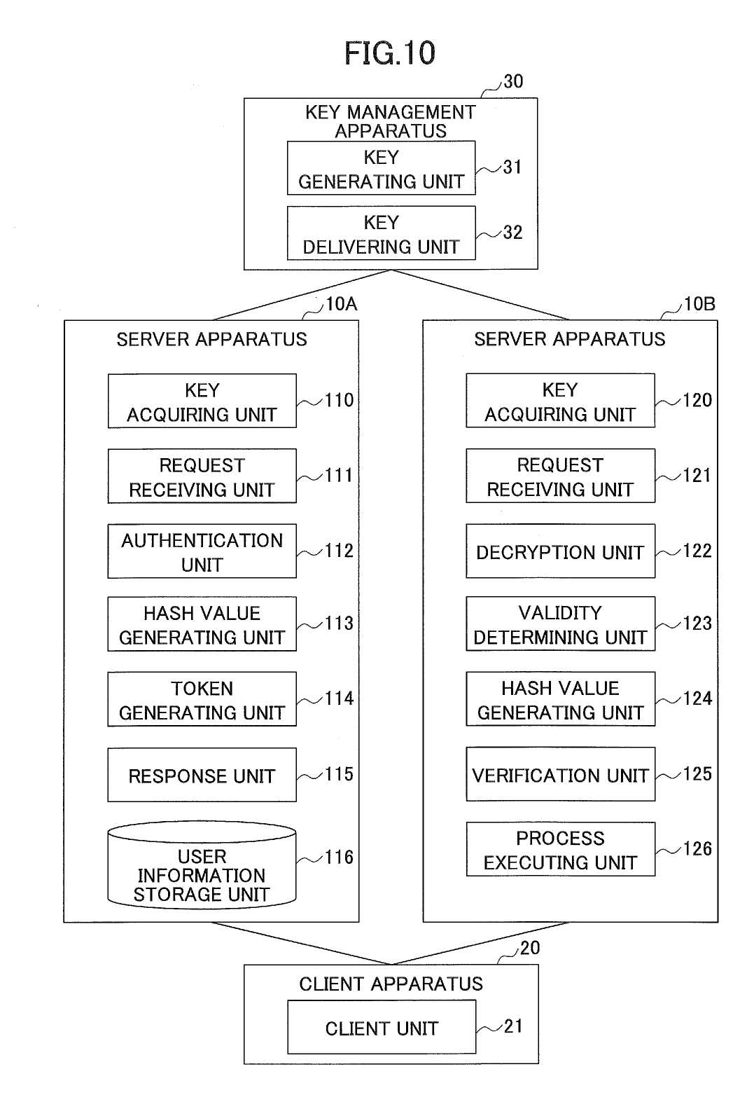

FIG. 10 illustrates an exemplary functional configuration of the information processing system according to the present embodiment.

In FIG. 10, the key management apparatus 30 includes a key generating unit 31 and a key delivering unit 32. These units may be implemented by a relevant process executed by a CPU of the key management apparatus 30 based on a program installed in the key management apparatus 30, for example.

The key generating unit 31 may be configured to repeatedly generate an encryption key at predetermined time intervals, for example. However, in some embodiments, the key generating unit 31 may be configured to generate the encryption key at a timing corresponding to when an instruction is input by a user, for example. The key delivering unit 32 delivers the generated encryption key to the server apparatuses 10 each time the encryption key is generated by the key generating unit 31. Note that in some embodiments, the same encryption key may be delivered to the server apparatuses 10, for example. In other embodiments, the encryption key that is delivered to the server apparatus 10A may be asymmetric to the encryption key that is delivered to the server apparatus 10B. That is, the encryption key that is delivered to the server apparatus 10A may be a private key, and the encryption key that is delivered to the server apparatus 10B may be a public key that forms a pair with the private key delivered to the server apparatus 10A. In this case, the key generating unit 31 generates two encryption keys including the private key and the public key.

The server apparatus 10A includes a key acquiring unit 110 in addition to the request receiving unit 111, the authentication unit 112, the hash value generating unit 113, the token generating unit 114, and the response unit 115 that are described above in connection with the first embodiment.

The key acquiring unit 110 of the server apparatus 10A acquires (receives) the encryption key that is delivered thereto from the key management apparatus 30. The encryption key that is acquired by the key acquiring unit 110 may be stored in the memory unit 103 or the secondary storage unit 102 of the server apparatus 10A, for example.

When a user is successfully authenticated by the authentication unit 112 and the hash value generating unit 113 generates a hash value of the user information of the user corresponding to the hash source information, for example, the token generating unit 114 encrypts the hash value generated by the hash value generating unit 113 and information indicating a validity period using the encryption key acquired by the key acquiring unit 110. Note that the encryption key used in the above encryption corresponds to the last encryption key acquired by the key acquiring unit 110 (the encryption key that is acquired most recently by the key acquiring unit 110).

The server apparatus 10B includes a key acquiring unit 120 in addition to the request receiving unit 121, the decryption unit 122, the validity determining unit 123, the hash value generating unit 124, the verification unit 125, and the process executing unit 126 that are described above in connection with the first embodiment.

The key acquiring unit 120 of the server apparatus 10B acquires (receives) the encryption key that is delivered by the key management apparatus 30. The encryption key that is acquired by the key acquiring unit 120 may be stored in the memory unit 103 or the secondary storage unit 102 of the server apparatus 10B, for example.

When the request receiving unit 121 receives a request including a subject that has been generated by the server apparatus 10A from the client unit 21, the decryption unit 122 decrypts the token in the subject included in the request received by the request receiving unit 121 using the encryption key acquired by the key acquiring unit 120. Note that the encryption key used in the above decryption corresponds to the last encryption key acquired by the key acquiring unit 120 (the encryption key that is acquired most recently by the key acquiring unit 120).

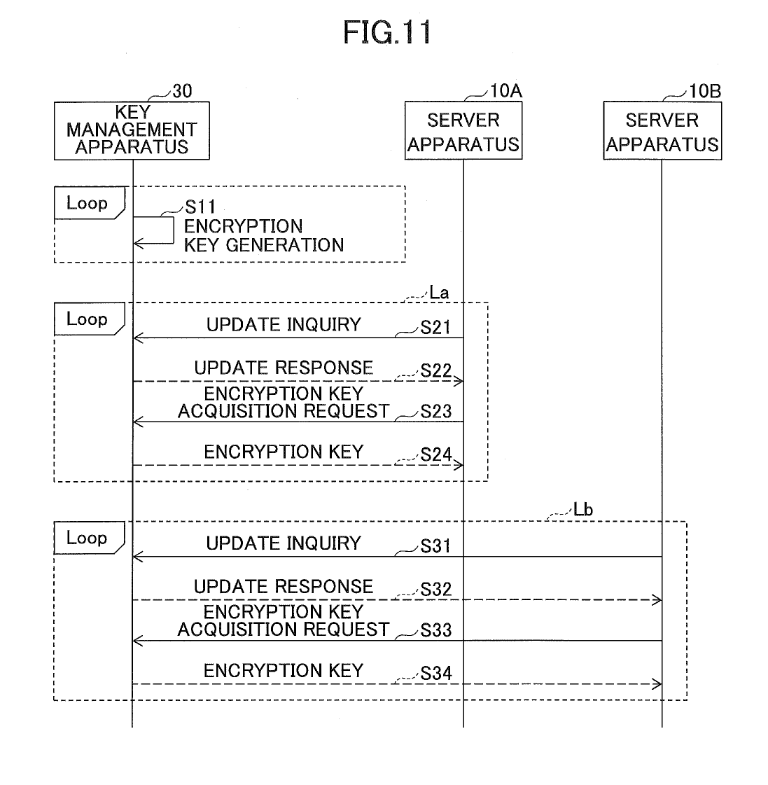

In the following, process steps that are executed in the information processing system 1 according to the present embodiment are described. FIG. 11 is a sequence chart illustrating exemplary process steps of a delivery process for delivering an encryption key to each of the server apparatuses 10.

The key generating unit 31 of the key management apparatus 30 repeatedly generates an encryption key at predetermined time intervals (step S11). Note that the predetermined time intervals may be set up by an administrator or the like, for example. Note, however, that in some embodiments, the key generating unit 31 may generate the encryption key at a timing corresponding when an instruction is input by a user, for example.

Meanwhile, the key acquiring unit 110 and the key acquiring unit 120 of the server apparatuses 10A and 10B conduct polling to check for an update of the encryption key (steps S21 and S31). Note that in FIG. 11, loop processes La and Lb are executed in parallel.

If the last encryption key generated by the encryption key generating unit 31 has not been delivered to the server apparatuses 10A and 10B, the key delivering unit 32 returns a response to the server apparatuses 10A and 10B indicating that the encryption key has been updated (hereinafter referred to as “update response”)(steps S22 and S32). Note that the polling conducted by the server apparatuses 10A and 10B may be long polling, for example. Long polling refers to a type of polling in which a response to an inquiry is not immediately returned but is instead returned at the time the need to return a response arises. In the present embodiment, the need to return a response arises when the encryption key is newly generated.

Upon receiving the update response, the key acquiring unit 110 and the key acquiring unit 120 each send acquisition requests for the encryption key to the key management apparatus 30 (steps S23 and S33). In response to such acquisition requests, the key delivering unit 32 of the key management apparatus 30 returns the most recent encryption key (the last encryption key generated by the key generating unit 31) to the server apparatuses 10A and 10B (steps S24 and S34).

Note that in some embodiments, the encryption key may be included in the update response and returned to the server apparatuses 10 along with the update response, for example. Also, in some embodiments, the key delivering unit 32 may actively deliver the newly generated encryption key to the server apparatuses 10 (push type delivery) rather than delivering the encryption key in response to an inquiry from each of the server apparatuses 10, for example.

To implement single sign-on in the information processing system 1 according to the present embodiment, process steps similar to those illustrated in FIG. 5 may be executed. Also, an authentication process similar to that illustrated in FIG. 6 may be executed. Further, a request response process similar to that illustrated in FIG. 8 may be executed.

Note that in the information processing system 1 according to the present embodiment, in step S205 of the authentication process of FIG. 6, the token generating unit 114 generates a token by encrypting the hash value generated by the hash value generating unit 113 and the date and time information indicating the validity period of the token using the last encryption key received by the key acquiring unit 110 (the encryption key received most recently by the key acquiring unit 110).

Also, in step S301 of the request response process of FIG. 8, the decryption unit 122 decrypts the token in the subject included in the request received by the request receiving unit 121 using the last encryption key received by the key acquiring unit 120 (the encryption key received most recently by the key acquiring unit 120).

Note that the encryption key update timing may be in between the execution timing of the authentication process of step S102 and the execution timing of the request response process of step S105 of FIG. 5. In this case, the encryption key used in step S205 of FIG. 6 and the encryption key used in step S301 of FIG. 8 may be different encryption keys. In the present descriptions, different encryption keys refer to encryption keys that are neither the same nor form a public and private key pair. Accordingly, in one preferred embodiment, when decryption of the token executed in step S301 of FIG. 8 is not successful, the decryption unit 122 may use an encryption key received before the encryption key that has been received most recently by the key acquiring unit 120 (the last encryption key) to decrypt the token. For example, the decryption unit 122 may successively attempt to decrypt the token using the encryption keys received before the last encryption key starting with the newest encryption key until the token is successfully decrypted. Once the decryption is successful, the process may proceed to step S303 of FIG. 8. Also, in some embodiments, the number of encryption keys to be used to decrypt the token may be limited to a predetermined number, for example.

As can be appreciated from the above, according to an aspect of the present embodiment, single sign-on may be achieved even when communication is not established between the server apparatus 10A and the server apparatus 10B. In other words, single sign-on may be achieved even when communication between the server apparatus 10A and the server apparatus 10B is disabled. In this way, dependency on communication in implementing single sign-on may be reduced.

Also, according to an aspect of the present embodiment, the encryption key used by the server apparatuses 10 may be periodically updated. In this way, security measures against leakage and prediction of the encryption key may be improved as compared to a case where the encryption key is fixed.

Note that the server apparatus 10A of the above-described embodiments is an example of a first information processing apparatus of the present invention. The server apparatus 10B is an example of a second information processing apparatus. The key acquiring unit 110 is an example of a first key receiving unit. The hash value generating unit 113 is an example of a first generating unit. The token generating unit 114 is an example of an encryption unit. The token is an example of encrypted data. The response unit 115 is an example of a response unit. The key acquiring unit 120 is an example of a second key receiving unit. The request receiving unit 121 is an example of a request receiving unit. The hash value generating unit 124 is an example of a second generating unit. The verification unit 125 is an example of a comparison unit.

Although the present invention has been described above with reference to certain illustrative embodiments, the present invention is not limited to these embodiments, and numerous variations and modifications may be made without departing from the scope of the present invention.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Application No. 2014-101334 filed on May 15, 2014 and Japanese Patent Application No. 2014-107754 filed on May 26, 2014, the entire contents of which are hereby incorporated by reference.

What is claimed is:

1. An information processing system comprising:
a first information processing apparatus that includes
an authentication unit configured to perform an authentication process with respect to information transmitted from a client apparatus;
a first generating unit configured to generate a hash value of predetermined information in a case where the authentication process by the authentication unit is successful;
an encryption unit configured to generate encrypted data by encrypting the hash value generated by the first generating unit using a first encryption key; and
a response unit configured to transmit the encrypted data and the predetermined information to the client apparatus; and
a second information processing apparatus that includes
a request receiving unit configured to receive a request transmitted from the client apparatus, the request including the encrypted data generated by the encryption unit and the predetermined information;
a decryption unit configured to decrypt the encrypted data included in the request received by the request receiving unit using a second encryption key, the second encryption key being the same as the first encryption key or forming a pair with the first encryption key;
a second generating unit configured to generate a hash value of the predetermined information included in the request received by the request receiving unit; and
a comparison unit configured to compare a decryption result obtained by the decryption unit with the hash value generated by the second generating unit;
wherein the second information processing apparatus executes a process in response to the request according to a comparison result of the comparison unit.

2. The information processing system as claimed in claim 1, wherein
the first information processing apparatus further includes a first key receiving unit configured to receive the first encryption key at a predetermined timing;
the encryption unit generates the encrypted data by encrypting the hash value using the first encryption key that is received most recently by the first key receiving unit;
the second information processing apparatus further includes a second key receiving unit configured to receive the second encryption key at the predetermined timing; and
the decryption unit decrypts the encrypted data included in the request received by the request receiving unit using the second encryption key that is received most recently by the second key receiving unit.

3. The information processing system as claimed in claim 2, wherein
when the decryption unit is unable to decrypt the encrypted data using the second encryption key that is received most recently by the second key receiving unit, the decryption unit decrypts the encrypted data using the second encryption key that is received earlier than the second encryption key received most recently by the second key receiving unit.

4. The information processing system as claimed in claim 2, wherein
when the decryption unit is unable to decrypt the encrypted data using the second encryption key that is received most recently by the second key receiving unit, the decryption unit decrypts the encrypted data using not more than a predetermined number of the second encryption keys that are received earlier than the second encryption key received most recently by the second key receiving unit.

5. The information processing system as claimed in claim 1, wherein
the encryption unit generates the encrypted data by encrypting the hash value generated by the first generating unit and date and time information; and
the second information processing apparatus executes the process in response to the request according to the date and time information included in the decryption result obtained by the decryption unit.

6. The information processing system as claimed in claim 1, wherein the predetermined information includes information relating to a user authenticated by the authentication unit.

7. An information processing method implemented by a first information processing apparatus and a second information processing apparatus, the information processing method comprising:
an authentication step that is executed by the first information processing apparatus and includes performing an authentication process with respect to information transmitted from a client apparatus;
a first generating step that is executed by the first information processing apparatus and includes generating a hash value of predetermined information in a case where the authentication process performed in the authentication step is successful;
an encryption step that is executed by the first information processing apparatus and includes generating encrypted data by encrypting the hash value generated in the first generating step using a first encryption key;
a response step that is executed by the first information processing apparatus and includes transmitting the encrypted data and the predetermined information to the client apparatus;
a request receiving step that is executed by the second information processing apparatus and includes receiving a request transmitted from the client apparatus, the request including the encrypted data and the predetermined information;
a decryption step that is executed by the second information processing apparatus and includes decrypting the encrypted data included in the request received in the request receiving step using a second encryption key, the second encryption key being the same as the first encryption key or forming a pair with the first encryption key;
a second generating step that is executed by the second information processing apparatus and includes generating a hash value of the predetermined information included in the request received in the request receiving step; and
a comparison step that is executed by the second information processing apparatus and includes comparing a decryption result obtained in the decryption step with the hash value generated in the second generating step;
wherein the second information processing apparatus executes a process in response to the request according to a comparison result of the comparison step.

8. The information processing method as claimed in claim 7, further comprising:
a first key receiving step that is executed by the first information processing apparatus and includes receiving the first encryption key at a predetermined timing; and
a second key receiving step that is executed by the second information processing apparatus and includes receiving the second encryption key at the predetermined timing;
wherein the encryption step includes generating the encrypted data by encrypting the hash value using the first encryption key that is received most recently in the first key receiving step; and
wherein the decryption step includes decrypting the encrypted data included in the request received in the request receiving step using the second encryption key that is received most recently in the second key receiving step.

9. The information processing method as claimed in claim 8, wherein
when the encrypted data cannot be decrypted in the decryption step using the second encryption key that is received most recently in the second key receiving step, the decryption step further includes decrypting the encrypted data using the second encryption key that is received earlier than the second encryption key received most recently in the second key receiving step.

10. The information processing method as claimed in claim 8, wherein
when the encrypted data cannot be decrypted in the decryption step using the second encryption key that is received most recently in the second key receiving step, the decryption step further includes decrypting the encrypted data using not more than a predetermined number of the second encryption keys that are received earlier than the second encryption key received most recently in the second key receiving step.

11. The information processing method as claimed in claim 7, wherein
the encryption step includes generating the encrypted data by encrypting the hash value generated in the first generating step and date and time information; and
the second information processing apparatus executes the process in response to the request according to the date and time information included in the decryption result obtained in the decryption step.

12. The information processing method as claimed in claim 7, wherein the predetermined information includes information relating to a user authenticated in the authentication step.

13. An information processing apparatus comprising:
an authentication unit configured to perform an authentication process with respect to information transmitted from a client apparatus;
a first generating unit configured to generate a first hash value of first predetermined information in a case where the authentication process by the authentication unit is successful;
an encryption unit configured to generate first encrypted data by encrypting the first hash value generated by the first generating unit using a first encryption key;
a response unit configured to transmit the first encrypted data and the first predetermined information to the client apparatus;
a request receiving unit configured to receive a request transmitted from the client apparatus, the request including second predetermined information and second encrypted data generated by encrypting a second hash value of the second predetermined information;
a decryption unit configured to decrypt the second encrypted data included in the request received by the request receiving unit using a second encryption key;
a second generating unit configured to generate the second hash value of the second predetermined information included in the request received by the request receiving unit;
a comparison unit configured to compare a decryption result obtained by the decryption unit with the second hash value generated by the second generating unit; and
a process executing unit configured to execute a process in response to the request according to a comparison result of the comparison unit.

14. The information processing apparatus as claimed in claim 13, further comprising:
a first key receiving unit configured to receive the first encryption key at a predetermined timing, wherein the encryption unit generates the first encrypted data by encrypting the first hash value using the first encryption key that is received most recently by the first key receiving unit; and
a second key receiving unit configured to receive the second encryption key at a predetermined timing, wherein the decryption unit decrypts the second encrypted data included in the request received by the request receiving unit using the second encryption key that is received most recently by the second key receiving unit.

15. The information processing apparatus as claimed in claim 14, wherein
when the decryption unit is unable to decrypt the second encrypted data using the second encryption key that is received most recently by the second key receiving unit, the decryption unit decrypts the second encrypted data using the second encryption key that is received earlier than the second encryption key received most recently by the second key receiving unit.

16. The information processing apparatus as claimed in claim 14, wherein
when the decryption unit is unable to decrypt the second encrypted data using the second encryption key that is received most recently by the second key receiving unit, the decryption unit decrypts the second encrypted data using not more than a predetermined number of the second encryption keys that are received earlier than the second encryption key received most recently by the second key receiving unit.

17. The information processing apparatus as claimed in claim 13, wherein
the first encrypted data and the second encrypted data are generated by encrypting date and time information; and
the process executing unit executes the process in response to the request according to the date and time information included in the decryption result obtained by the decryption unit.

18. The information processing apparatus as claimed in claim 13, wherein the first predetermined information and the second predetermined information include information relating to a user authenticated by the authentication unit.
